(19) United States
(12) Patent Application Publication
(10) Pub. No.: US 2008/0259478 A1
(43) Pub. Date: Oct. 23, 2008

(54) Optical filter for display apparatus

(75) Inventors: Ji-Yoon Seo, Gyeongsangbuk-do (KR); Dong-Keun Sin, Hwaseong-si (KR); Sang-Yoon Oh, Gyeongsangbuk-do (KR); Ji-Young Kim, Gyeongsangbuk-do (KR); Seok-Won Kim, Busan (KR)

Correspondence Address: STAAS & HALSEY LLP, SUITE 700, 1201 NEW YORK AVENUE, N.W., WASHINGTON, DC, 20005, US

(73) Assignee: SAMSUNG CORNING PRECISION GLASS CO., LTD., Gumi-si (KR)

(21) Appl. No.: 12/081,775

(22) Filed: Apr. 21, 2008

(30) Foreign Application Priority Data
Apr. 23, 2007 (KR) 10-2007-0039405

(51) Int. Cl. G02B 5/22; G02B 1/10

(52) U.S. Cl. 359/885

(57) ABSTRACT

Disclosed is an optical filter for a display filter in which an adhesive layer excluding organic acidic substances is used, thereby achieving superior durability. The optical filter includes an anti-reflection film, a transparent substrate, a mesh film, and a color correction film. In this instance, an inorganic acidic adhesive layer is formed on a surface of at least one of the anti-reflection film, the mesh film, and the color correction film.

### CROSS-REFERENCE TO RELATED APPLICATION

This application claims the benefit of Korean Patent Application No. 10-2007-0039405, filed on Apr. 23, 2007 in the Korean Intellectual Property Office, the entire disclosure of which is incorporated herein by reference.

### BACKGROUND OF THE INVENTION

1. Field of the Invention

The present invention relates to an optical filter for a display apparatus, and more particularly, to an optical filter for a display apparatus in which superior durability can be achieved even under unfavorable conditions and a change in the outer surface color is not shown.

2. Description of Related Art

Plasma display panel (hereinafter, referred to as PDP) apparatuses are generally gaining popularity as next-generation display apparatuses to simultaneously satisfy a trend of becoming larger, and of becoming thinner, when compared with cathode-ray tubes (CRTs) representative of existing display apparatuses. Also, the PDP apparatuses may exhibit superior display characteristics such as a display capacity, brightness, a contrast, afterimage, a viewing angle, and the like.

However, the PDP apparatus has a defect in that emission of electromagnetic (EM) radiation and near infrared (NIR) radiation with respect to the driving characteristics may be not avoidable due to the use of inert gases such as argon (Ar), neon (Ne), or xenon (Xe). In this regard, the NIR radiation of a bandwidth of 800 to 1200 nm emitted from the PDP apparatus may cause peripheral equipments such as wireless telephones, remote controls, and the like to malfunction, and also the EM radiation emitted from the PDP apparatus may have harmful effects on human bodies or peripheral equipments. Accordingly, there arises a need for an optical filter for shielding the EM radiation and the NIR radiation in addition to reducing a reflected light generated due to an external light, thereby improving the visibility.

General optical filters for the PDP are divided into conductive layer type filters and mesh type filters. In the case of the conductive layer type filter, a transparent thin film with a high refractive index and a low refractive index for shielding the NIR radiation and EM radiation, and a conductive layer, which is formed by stacking silver-based or aluminum-based metal thin films or blocker layers acting as a protection layer for a metal thin film, may be used. In the mesh type filter, the mesh film for shielding the EM radiation, which is formed using an etching scheme or plating scheme, an Near-Infrared (NIR) film for shielding the NIR radiation, or a combination of the mesh type and conductive layer type filters may be used. Also, each type filter may include a tempered glass to prevent cracking and shattering, a color correction film for improving a contrast and color purity of red color, an anti-reflection (AR) film for preventing reflection, and the like.

The NIR film and the color correction film from among these films being comprised of the optical filter for the PDP may have relatively great effects on optical characteristics of the overall filters such as transmittance and outer surface color in a visible ray of 400 to 800 nm, and NIR absorbing property in the NIR of 800 to 1200 nm.

Accordingly, attempts for maintaining color purity and transmittance of the visible ray using a cyanine-based colorant, which exhibits superior NIR absorbing property in about 550 to 620 nm emitted from Ne gas, and also attempts for shielding an NIR radiation of about 800 to 1250 nm emitted from Xe gas have been made as disclosed in Korean Patent publication No. 2003-0066178, US. Patent publication No. 5804102, and Japanese Patent Laid-Open Nos. 2000-67765 and 2002-200711.

However, conventional optical filters manufactured by the conventional method have problems in that since a change in a transmission chromaticity is greater than 0.010 after testing durability of the optical filter for moisture resistance, heat resistance, ability to withstand cyclic heating, ability to withstand ultraviolet (UV) radiation, and the like, a change in the outer surface color is significantly great under unfavorable conditions.

### SUMMARY OF THE INVENTION

An aspect of the present invention provides an optical filter for a display apparatus in which a superior durability can be achieved.

An aspect of the present invention provides an optical filter for a display apparatus in which a change in a transmission chromaticity after testing durability for the optical filter is less than a predetermined value.

According to an aspect of the present invention, there is provided an optical filter for a display apparatus, which includes an anti-reflection film, a transparent substrate, a mesh film, and a color correction film. In this instance, an inorganic acidic adhesive layer is formed on a surface of at least one of the anti-reflection film, the mesh film, and the color correction film. However, in the present invention, each film may perform multiple functions. Alternatively, functional films such as a protection film, an external light-shielding film, and the like, other than the above films may be independently used

In this instance, the anti-reflection film for preventing reflection of an external light may include high refractive layers such as an anti-smudge layer, indium (In), antimony (Sb), and a tin (Sn)-based organic compounds, and fluorosilane-based low refractive layers or fluoroacrylic-based low refractive layers. The anti-reflection film may be made of a polyethylene terephthalate (PET) or a triacetylcellulose (TAC).

In this instance, a tempered glass, which is thermally and chemically reinforced, or a PET may be used for the transparent substrate to prevent cracking and shattering, and the mesh film functions to shield the EM radiation. Also, the color correction film may be selected from the group consisting of a color correction film with a cyanine-based colorant, a near-infrared absorbing film with a nickel complex or a DIIMONIUM-based colorant, or a combination of the color correction film and the near-infrared absorbing film.

In this instance, the inorganic acidic adhesive layer may be formed on a surface of at least one of the respective films. The inorganic acidic adhesive layer may be acquired by removing acidic substances from organic compounds. Here, as examples for acidic organic compounds, a carboxylic acid, a phenol, an enol, a thiophenol, an aromatic sulfonic acid, and first and second nitro compounds may be listed.

Here, the anti-reflection film, the transparent substrate, the mesh film, and the Color correction film may be variously stacked one over another depending on an intention of the designer, thereby fabricating the optical filter.

In this instance, the display apparatus according to the present invention is any one of a large-sized display apparatus corresponding to one selected from among a Plasma Display Panel (PDP) apparatus with lattice patterned pixels which can realize RGB (Red, Green, Blue), an Organic Light Emitting Diode (OLED) apparatus, a Liquid Crystal Display (LCD) apparatus, and a Field Emission Display (FED) apparatus, a small-sized mobile display apparatus corresponding to any one of a display window of a small-sized game device and a display window of a mobile phone, and a flexible display apparatus.

### BRIEF DESCRIPTION OF THE DRAWING

The above and other aspects of the present invention will become apparent and more readily appreciated from the following detailed description of certain exemplary embodiments of the invention, taken in conjunction with the accompanying drawing of which:

FIG. 1 is a cross-sectional view illustrating an optical filter for a display apparatus according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawing, wherein like reference numerals refer to the like elements throughout. The exemplary embodiments are described below in order to explain the present invention by referring to the FIGURE.

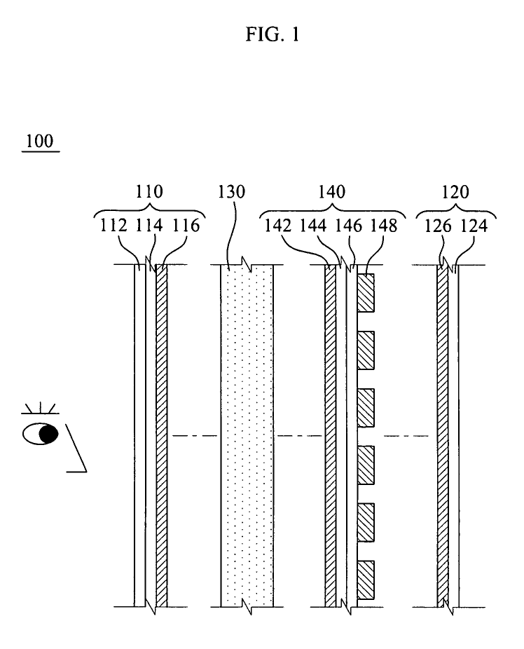

FIG. 1 is a cross-sectional view illustrating an optical filter for a display apparatus according to an exemplary embodiment of the present invention.

Referring to FIG. 1, an optical filter 100 for the display apparatus according to the present exemplary embodiment includes an anti-reflection film 110, a transparent substrate 130, a mesh film 140, and a color correction film 120. In this instance, an inorganic acidic adhesive layer is formed on a surface of at least one of the respective films.

The anti-reflection film 110 may function to prevent an external light entering from a viewer side from being reflected to the outside, and improve a contrast ratio of the display apparatus, and may include a transparent supporter 114, an anti-smudge layer or anti-reflection layer 112, and a Neon-Cut (Ne-Cut) colorant layer 116 within an adhesive layer. In this instance, at least one of the anti-smudge layer and the anti-reflection layer may be formed on a front surface of the transparent supporter 114, as necessary, and the Ne-Cut colorant layer within the adhesive layer may be formed on a rear surface thereof.

A tempered glass, which is thermally and chemically reinforced, or a polyethylene terephthalate (PET) substance may be used for the transparent substrate 130 to prevent cracking and shattering.

The mesh film 140 for shielding electromagnetic (EM) radiation may be manufactured by etching or plating schemes, and made of copper, aluminum, silver, or an alloy thereof. The mesh film 140 may include an adhesive layer 142, a transparent supporter 144, another adhesive layer 146 and a metal or fiber mesh 148.

The color correction film 120 may be selected from the group consisting of a color correction film with a cyanine-based colorant, a near-infrared absorbing film with a nickel complex or a diimonium-based colorant, or a combination of the color correction film and the near-infrared absorbing film. In this case, the correction film may include an adhesive layer 126 formed on a surface thereof. The cyanine-based colorant has a maximum absorption rate in about a 550 to 620 nm wavelength range, and the nickel complex or the diimonium-based colorant has a maximum absorption rate in about an 800 to 1200 nm wavelength range. The cyanine-based colorant may be selected from the group consisting of a carbocyanine compound, a dicarbocyanine compound, a metal chelate compound thereof, or a mixture thereof. Also, the correction film 120 may be fabricated such that colorants are added to resin such as PET and then thermoformed by a typical method, pigments containing colorants are prepared and coated on a transparent polymer film, or colorants are added to the adhesive layer. In this instance, inorganic pigments/dyes and organic pigments/dyes may be used, as necessary.

For attachment between respective films, an inorganic acidic adhesive layer may be formed on a surface of at least one of the respective films. The inorganic acidic adhesive layer may be acquired by removing acidic materials from organic compounds. Here, as examples for acidic organic compounds, a carboxylic acid, a phenol, an enol, a thiophenol, an aromatic sulfonic acid, and first and second nitro compounds may be listed.

The optical filter of the present exemplary embodiment constructed as described above may prevent discoloration of the adhesive layer adopting an adhesive layer excluding organic substances, and therefore a change in a transmission chromaticity may be less than about 0.006 even after testing durability of the optical filter for moisture resistance, heat resistance, ability to withstand cyclic heating, ability to withstand ultraviolet (UV) radiation, and the like.

The following Examples and Comparison Examples will illustrate the present invention in detail, but the present invention is not limited thereto.

### Example 1

Materials as shown in the following Table 1 were well stirred to prepare a mixed solution, and the prepared mixed solution was coated on an easy-adhesion treated PET film with the PET film having a thickness of 100 μm (product name: A 4300 made by Toyobo Co., Ltd, Japan) and dried in a dryer. In this instance, the coated thickness was maintained to be about 8 to 10 μm and an interior temperature of the dryer was adjusted to be about 110° C. to 130° C., and thereby the correction film 124 having the Ne-cut function and NIR function was fabricated.

TABLE 1

| Materials | Amount used |
|---|---|
| Acryl based resin (IR-G205 made by | 75.92 Wt % |
| NIPPON SHOKUBAI Co., Ltd, Japan) | (solid content of 30%) |
| Ne absorbent (TY-102 made by ASAHI | 0.03 Wt % |
| DENKA Co., Ltd, Japan) | |
| NIR absorbent (IRG-022 made by | 0.80 Wt % |
| NIPPON KAYAKU, Co., Ltd, Japan) | |
| NIR absorbent (CY-40BE made by | 0.05 Wt % |
| NIPPON KAYAKU, Co., Ltd, Japan) | |
| NIR absorbent (IR-12 made by NIPPON | 0.20 Wt % |
| SHOKUBAI Co., Ltd, Japan) | |
| Methyl-ethyl ketone | 23.0 Wt % |

Materials for an adhesive agent as shown in the following Table 2 were well mixed, and the mixed materials were coated on a release film with a thickness of about 75 μm (product name: cosmoshine made by Toyobo, Japan) and dried in the dryer. In this instance, the coated thickness was maintained to be about 18 to 25 μm, the interior temperature of the dryer was adjusted to be about 60 to 100° C., and then the dried film was adhered to the Color correction film 124 fabricated as described in Table 1, thereby fabricating the correction film 120.

TABLE 2

| Materials | Amount used | |
|---|---|---|
| organic acidic material-free acrylic resin | 58.0 | Wt % |
| based adhesive agent (PTR-500 made by | | |
| NIPPON KAYAKU, Co., Ltd, Japan) | | |
| Hardener (M12ATY-102 made by | 0.3 | Wt % |
| NIPPON KAYAKU, Co., Ltd, Japan) | | |
| Hardener (L45EY made by NIPPON | 0.2 | Wt % |
| KAYAKU, Co., Ltd, Japan) | | |
| Hardener (C-50 made by SOKEN | 0.06 | Wt % |
| KAGAKU, Co., Ltd, Japan) | | |
| UV absorbent (chimabin 109 made by | 0.6 | Wt % |
| CHIBA GAIGI, Co., Ltd, Japan) | | |
| Yellow colorant (kaya-set of yellow-GN | 0.003 | Wt % |
| made by NIPPON KAYAKU, Co., Ltd, | | |
| Japan) | | |
| Blue colorant (kaya set of blue-N made by | 0.004 | Wt % |
| NIPPON KAYAKU, Co., Ltd, Japan) | | |
| Methyl-ethyl ketone | 40.7 | Wt % |

Next, the correction film 120 was adhered on the transparent substrate 130 using a lamination device, and the mesh film 140 and the anti-reflection film 110 (Realook 7702UV made by Nippon Oil & Fat, Japan) were adhered to each other, thereby fabricating an optical filter. Then, a test of durability for the optical filter was performed and a change in transmission chromaticity was ascertained as shown in Table 3. Table 4 shows conditions of the test of the durability.

As to the change in the transmission chromaticity after testing the durability, X was changed by a maximum of about 0.002 to 0.003, and Y was changed by about 0.001 to 0.005.

TABLE 3

| | | | | Transmission | | | Transmission | | |
|---|---|---|---|---|---|---|---|---|---|
| | Transmittance (D65) | | | chromaticity (X) | | | chromaticity (Y) | | |
| Items | Before | After | Δ | Before | After | Δ | Before | After | Δ |
| Heat | 46.3 | 46.0 | 0.3 | 0.301 | 0.304 | 0.003 | 0.319 | 0.323 | 0.004 |
| resistance | | | | | | | | | |
| test | | | | | | | | | |
| Moisture | 46.0 | 46.4 | 0.4 | 0.301 | 0.303 | 0.002 | 0.319 | 0.324 | 0.005 |
| resistance | | | | | | | | | |
| test | | | | | | | | | |
| Heat | 45.9 | 45.9 | 0 | 0.301 | 0.301 | 0.000 | 0.318 | 0.309 | 0.001 |
| cycle test | | | | | | | | | |
| UV test | 46.2 | 46 | 0.2 | 0.301 | 0.303 | 0.002 | 0.319 | 0.323 | 0.004 |

TABLE 4

| Items | Estimation methods |
|---|---|
| Heat resistance test | 80° C. in Electric furnace for 500 hours |
| Moisture resistance test | 60° C., 90% RH for 500 hours |
| Heat cycle test | −30° C. to 60° C., 50 cycles (1 cycle = 8 |
| | hours) |
| UV test | Lamp Irradiance 0.77 W/m²/nm, 100 hr |
| | Lamp Type: UV340 |

### Comparative Example 1

In an optical filter constructed such that the anti-reflection film was positioned on a front surface of the transparent substrate, and the mesh film and the correction film were sequentially adhered on a rear surface of the transparent substrate, a change in the transmission chromaticity was measured after testing durability for the optical filter. The anti-reflection film was comprised of an anti-smudge layer formed on a surface of a polyurethane-based transparent supporter, an Ne-Cut colorant layer within an adhesive layer (PSA, pressure sensitive adhesive) formed on another surface of the transparent supporter, a mesh film, and a color correction film. A configuration of the adhesive layer (PSA) is shown in the following Table 5.

In this instance, a test of durability for the optical filter was performed in the same manner as the above Example 1, and the results are shown in Table 6, in which a change in the transmission chromaticity was ascertained after testing the durability.

TABLE 5

| Materials | Amount used | |
|---|---|---|
| Acrylic resin-based adhesive agent (PTR-5000 | 57.7 Wt % | 58.0 Wt % |
| made by NIPPON KAYAKU, Co., Ltd, Japan) | | |
| Carboxylic acid (organic acid substance) | 0.3 | Wt % |
| Hardener (M12ATY-102 made by NIPPON | 0.3 | Wt % |
| KAYAKU, Co., Ltd, Japan) | | |
| Hardener (L45EY made by NIPPON KAYAKU, | 0.2 | Wt % |
| Co., Ltd, Japan) | | |
| Hardener (C-50 made by SOKEN KAGAKU, | 0.06 | Wt % |
| Co., Ltd, Japan) | | |
| UV absorbent (chimabin 109 made by CHIBA | 0.6 | Wt % |
| GAIGI, Co., Ltd, Japan) | | |
| Yellow colorant (kaya set of yellow-GN made by | 0.003 | Wt % |
| NIPPON KAYAKU, Co., Ltd, Japan) | | |
| Blue colorant (kaya set of blue-N made by | 0.004 | Wt % |
| NIPPON KAYAKU, Co., Ltd, Japan) | | |
| Methyl-ethyl ketone | 40.7 | Wt % |

TABLE 6

| | | | | Transmission | | | Transmission | | |
|---|---|---|---|---|---|---|---|---|---|
| | Transmittance (D65) | | | chromaticity (X) | | | chromaticity (Y) | | |
| Items | Before | After | Δ | Before | After | Δ | Before | After | Δ |
| Heat | 47.8 | 47.3 | 0.5 | 0.300 | 0.298 | 0.002 | 0.320 | 0.329 | 0.009 |
| resistance | | | | | | | | | |
| test | | | | | | | | | |
| Moisture | 47.4 | 47.2 | 0.2 | 0.299 | 0.305 | 0.006 | 0.320 | 0.334 | 0.014 |
| resistance | | | | | | | | | |
| test | | | | | | | | | |
| Heat | 47.9 | 47.8 | 0.1 | 0.299 | 0.297 | 0.002 | 0.319 | 0.322 | 0.003 |
| cycle test | | | | | | | | | |
| UV test | 47.9 | 47.8 | 0.1 | 0.300 | 0.302 | 0.002 | 0.320 | 0.339 | 0.019 |

Unlike the above Example 1, measurements of the transmission chromaticity of the heat resistance, moisture resistance, and ability to withstand UV tests show changes of 0.009, 0.014, and 0.019, respectively.

### Comparative Example 2

In an optical filter constructed such that the anti-reflection film was positioned on a front surface of the transparent substrate, and the mesh film and the color correction film were sequentially adhered on a rear surface of the transparent substrate, a change in the transmission chromaticity was measured after testing durability for the optical filter. The anti-reflection film was comprised of an anti-reflection layer formed on a surface of a PET-based transparent supporter, an adhesive layer (PSA) formed on another surface of the transparent supporter, a mesh film, and a color correction film. A configuration of the adhesive layer (PSA) is shown in the following Table 7.

In this instance, a test of durability for the optical filter was performed in the same manner as the above Example 1, and the results are shown in Table 8, in which a change in the transmission chromaticity was ascertained after testing the durability.

TABLE 7

| Materials | Amount used | |
|---|---|---|
| Acrylic resin-based adhesive agent (PTR-5000 | 57.6 Wt % | 58.0 Wt % |
| made by NIPPON KAYAKU, Co., Ltd, Japan) | | |
| Sulfonic acid (organic acid substance) | 0.4 | Wt % |
| Hardener (M12ATY-102 made by NIPPON | 0.3 | Wt % |
| KAYAKU, Co., Ltd, Japan) | | |
| Hardener (L45EY made by NIPPON KAYAKU, | 0.2 | Wt % |
| Co., Ltd, Japan) | | |
| Hardener (C-50 made by SOKEN KAGAKU, | 0.06 | Wt % |
| Co., Ltd, Japan) | | |
| UV absorbent (chimabin 109 made by CHIBA | 0.6 | Wt % |
| GAIGI, Co., Ltd, Japan) | | |
| Yellow colorant (kaya set of yellow-GN made by | 0.003 | Wt % |
| NIPPON KAYAKU, Co., Ltd, Japan) | | |
| Blue colorant (kaya set of blue-N made by | 0.004 | Wt % |
| NIPPON KAYAKU, Co., Ltd, Japan) | | |
| Methyl-ethyl ketone | 40.7 | Wt % |

TABLE 8

| | | | | Transmission | | | Transmission | | |
|---|---|---|---|---|---|---|---|---|---|
| | Transmittance (D65) | | | chromaticity (X) | | | chromaticity (Y) | | |
| Items | Before | After | Δ | Before | After | Δ | Before | After | Δ |
| Heat | 44.9 | 44.4 | 0.5 | 0.313 | 0.318 | 0.005 | 0.328 | 0.341 | 0.013 |
| resistance | | | | | | | | | |
| test | | | | | | | | | |
| Moisture | 44.9 | 45 | 0.1 | 0.313 | 0.316 | 0.003 | 0.329 | 0.339 | 0.010 |
| resistance | | | | | | | | | |
| test | | | | | | | | | |
| Heat | 45.2 | 45.2 | 0 | 0.314 | 0.313 | 0.001 | 0.330 | 0.330 | 0.000 |
| cycle test | | | | | | | | | |
| UV test | 44.9 | 45.4 | 0.5 | 0.314 | 0.318 | 0.004 | 0.329 | 0.339 | 0.010 |

Unlike the above Example 1, measurements of the transmission chromaticity of the heat resistance, moisture resistance, and ability to withstand UV tests show changes of 0.009, 0.014, and 0.019, respectively.

As described above, according to the present invention, there is provided the optical filter for the display apparatus, in which an adhesive layer excluding organic acidic substances is used, thereby achieving superior durability.

According to the present invention, there is provided the optical filter for the display apparatus, in which the change in the transmission chromaticity is less than 0.006 even after testing durability such as moisture resistance, heat resistance, ability to withstand cyclic heating, ability to withstand UV radiation, and the like, whereby change in the outer surface color is not shown even under unfavorable conditions.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An optical filter for a display apparatus comprising:
an anti-reflection film,
a transparent substrate,
a mesh film, and
a color correction film, wherein
an inorganic acidic adhesive layer is formed on a surface of at least one of the anti-reflection film, the mesh film, and the color correction film.

2. The optical filter of claim 1, wherein the color correction film is selected from the group consisting of a color correction film with a cyanine-based colorant, a near-infrared absorbing film with a nickel complex or a diimonium-based colorant, or a combination of the color correction film and the near-infrared absorbing film.

3. The optical filter of claim 2, wherein the cyanine-based colorant is selected from the group consisting of a carbocyanine compound, a dicarbocyanine compound, a metal chelate compound of a carbocyanine compound or a dicarbocyanine compound, or a mixture thereof.

4. The optical filter of claim 1, wherein a change in a transmission chromaticity is less than 0.006 even after testing durability of the optical filter for the display apparatus.

5. The optical filter of claim 1, wherein the inorganic acidic adhesive layer is configured to exclude a carboxylic acid, a phenol, an enol, a thiopenol, an aromatic sulfonic acid, and first and second nitro compounds.
